(19) United States
(12) Patent Application Publication
(10) Pub. No.: US 2009/0187479 A1
(43) Pub. Date: Jul. 23, 2009

(54) CONVERSION TRACKING FOR PAID SEARCH MARKET

(75) Inventors: Jason D. Hartline, Chicago, IL (US); Liad Blumrosen, Sunnyvale, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/017,340

(22) Filed: Jan. 22, 2008

(51) Int. Cl. G06Q 30/00

(52) U.S. Cl. 705/14

(57) ABSTRACT

Conversion rates and tracking data may be considered in conjunction with a paid search market. A generalized second price (GSP) auction may be extended by incorporating conversion rates and tracking data in the payment rule. Such an extension is referred to as a generalized acquisition-aware second price (GASP) auction. A simplified version of GASP, referred to as simplified generalized acquisition-aware second price or SGASP, does not use conversion tracking for each advertiser.

### BACKGROUND

Paid search is an advertising model used on search engines, advertising networks, and content websites, where advertisers only pay when a user clicks on an advertisement to visit the advertiser's website. Paid search is also known as pay-per-click or PPC. Advertisers bid on keywords they predict their target market will use as search terms when they are looking for a product or service. When a user types a keyword query matching the advertiser's keyword list, or views a page with relevant content, the advertiser's advertisement may be shown. These advertisements are called a “sponsored link” or “sponsored ads” and appear next to or above the natural results on search engine results pages, or anywhere a webmaster chooses on a content page.

A generalized second price auction (GSP) is a mechanism which is used by search engines to sell online advertising. The number of advertisements that the search engine can show to a user is limited, and different positions or slots on the search results page are more desirable for advertisers. Hence, search engines typically use an auction system for allocating the slots to advertisers. Currently, the mechanisms most widely used by search engines are based on GSP.

In a GSP auction for a specific keyword, advertisers submit bids stating their maximum willingness to pay for a click. When a user enters a keyword, they receive search results along with sponsored links, the latter shown in decreasing order of bids. In particular, the advertisement with the highest bid is displayed at the top slot, the advertisement with the next highest bid is displayed in the second position (the next lower slot), and so on. If a user subsequently clicks on an advertisement in position i, that advertiser is charged by the search engine an amount equal to the next highest bid, i.e., the bid of an advertiser in position (i+1). If a search engine offered only one advertisement per result page, this mechanism would be equivalent to a standard second price auction. With multiple positions available, the GSP generalizes the second price auction. Here, each advertiser pays the next highest advertiser's bid.

Recent data analysis of conversion rates for advertisements in paid search suggests that bottom slots have higher conversion rates. Recent theoretical analysis shows that this can lead to game theoretic instability and/or lack of a good equilibrium in a GSP auction.

### SUMMARY

Conversion rates and tracking data may be considered in conjunction with a paid search market. In an implementation, a generalized second price auction may be extended by incorporating conversion rates and tracking data. Such an extension is referred to as a generalized acquisition-aware second price (GASP) auction.

In another implementation, a simplified version of GASP, referred to as simplified generalized acquisition-aware second price or SGASP, is provided that does not use conversion tracking for each advertiser.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an implementation of a system that may be used to provide conversion tracking for a paid search market;

FIG. 2 is an operational flow of an implementation of a method for a generalized second price (GSP) auction;

FIG. 3 is an operational flow of an implementation of a method of a generalized acquisition-aware second price (GASP) auction;

FIG. 4 is an operational flow of an implementation of a method of a simplified generalized acquisition-aware second price (SGASP) auction; and

FIG. 5 shows an exemplary computing environment.

### DETAILED DESCRIPTION

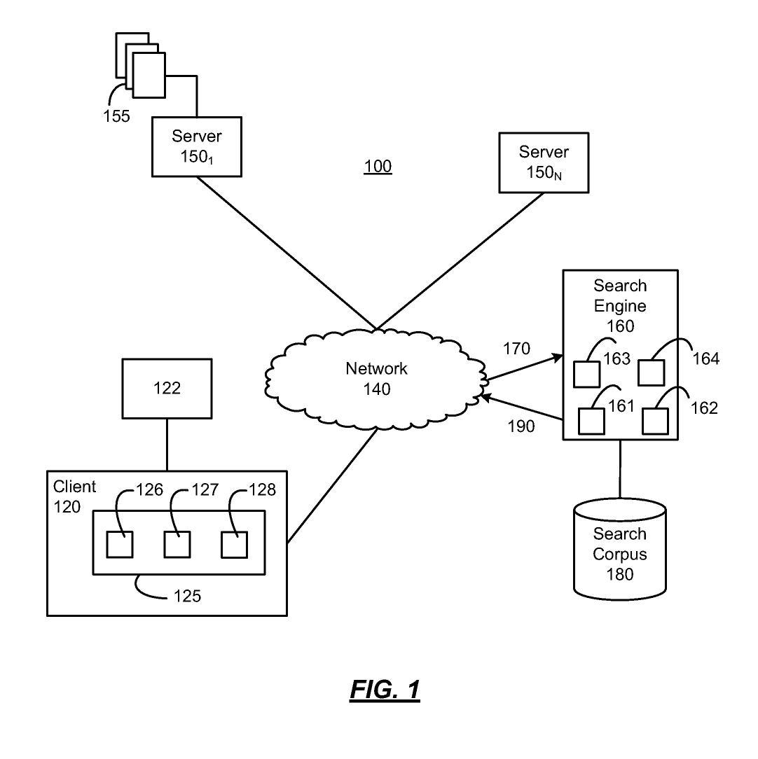

FIG. 1 is a block diagram of an implementation of a system that may be used to provide conversion tracking for a paid search market. FIG. 1 illustrates an exemplary network environment 100. In the network 100, a client 120 can may communicate through a network 140 (e.g., Internet, WAN, LAN, 3G, or other communication network), with a plurality of servers 150₁ to 150_{N}. The client 120 may communicate with a search engine 160. The client 120 may by configured to communicate with any of the servers 150₁ to 150_{N} and the search engine 160, to access, receive, retrieve and display media content and other information such as web pages 155, websites, and advertisements. In an implementation, an advertiser may be associated with a server.

In some implementations, the client 120 may include a desktop personal computer, workstation, laptop, PDA, cell phone, or any WAP-enabled device or any other computing device capable of interfacing directly or indirectly with the network 140. The client 120 may run an HTTP client, e.g., a browsing program, such as MICROSOFT INTERNET EXPLORER or other browser, or a WAP-enabled browser in the case of a cell phone, PDA or other wireless device, or the like, allowing a user of the client 120 to access, process and view information and pages available to it from the servers 150₁ to 150_{N}.

The client 120 may also include one or more user interface devices 122, such as a keyboard, a mouse, touch-screen, pen or the like, for interacting with a graphical user interface (GUI) provided by the browser on a display (e.g., monitor screen, LCD display, etc.), in conjunction with pages, forms and other information provided by the servers 150₁ to 150_{N} or other servers. Implementations described herein are suitable for use with the Internet, which refers to a specific global internetwork of networks. However, it should be understood that other networks can be used instead of or in addition to the Internet, such as an intranet, an extranet, a virtual private network (VPN), a non-TCP/IP based network, any LAN or WAN or the like.

According to an implementation, a client application 125 executing on the client 120 may include instructions for controlling the client 120 and its components to communicate with the servers 150₁ to 150_{N} and the search engine 160 and to process and display data content received therefrom. Additionally, the client application 125 may include various software modules for processing data and media content. For example, the client application 125 may include one or more of a search module 126 for processing search requests and search result data, a user interface module 127 for rendering data and media content in text and data frames and active windows, e.g., browser windows and dialog boxes, and an application interface module 128 for interfacing and communicating with various applications executing on the client 120. Further, the interface module 127 may include a browser, such as a default browser configured on the client 120 or a different browser.

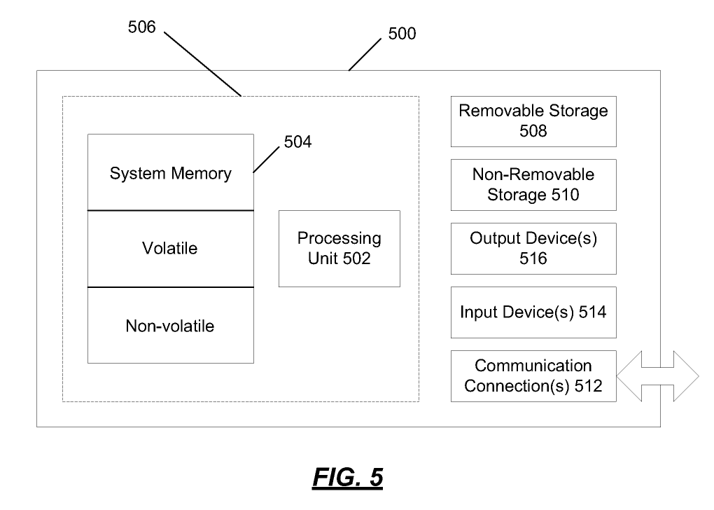

According to an implementation, the search engine 160 is configured to provide search result data, advertisements, and media content to the client 120, and the servers 150₁ to 150_{N} are configured to provide data and media content such as web pages to the client 120, for example, in response to links selected in search result pages provided by the search engine 160. The search engine 160 may reference various collection technologies for collecting information from the World Wide Web and for populating one or more indexes with, for example, pages, links to pages, etc. Such collection technologies include automatic web crawlers, spiders, etc., as well as manual or semi-automatic classification algorithms and interfaces for classifying and ranking web pages within a hierarchical structure. In certain aspects, the search engine 160 may also be configured to have an advertisement engine 161 that gathers, maintains and displays ranked advertisements, a click data engine 162 that gathers and maintains click-through rates and click data, and a payment engine 163 that charges advertisers based on clicks as further described herein. The search engine 160 may also have an auction engine 164 that performs auctions such as those described herein. An example search engine may comprise, or be comprised within, a computing environment such as that described with respect to FIG. 5.

In an implementation, the search engine 160 may be configured to provide data and advertisements responsive to a search query 170 received from the client 120, via the search module 126. The servers 150₁ to 150_{N} and 160 may be part of a single organization, e.g., a distributed server system such as that provided to users by search provider, or they may be part of disparate organizations. The servers 150₁ to 150_{N} and the search engine 160 each may include at least one server and an associated database system, and may include multiple servers and associated database systems, and although shown as a single block, may be geographically distributed.

According to an implementation, the search engine 160 may include algorithms that provide search results and advertisements 190 to users in response to the search query 170 received from the client 120. The search query 170 may be transmitted to the search engine 160 to initiate an Internet search (e.g., a web search). The search engine 160 locates content matching the search query 170 from a search corpus 180. The search corpus 180 represents content that is accessible via the World Wide Web, the Internet, intranets, local networks, and wide area networks.

The search engine 160 may retrieve content from the search corpus 180 that matches the search query 170 and transmit the matching content (i.e., search results) to the client 120 in the form of a web page to be displayed in the user interface module 127. In some implementations, the most relevant search results are displayed to a user in the user interface module 127. The search engine 160 may also provide advertisements to the client 120 in response to the search query 170.

It is common for a search market to provide conversion tracking to advertisers. This allows advertisers to receive detailed statistics of how the clicks that they are paying for in a pay-per-click market convert into profit. When an advertiser opts-in to conversion tracking, an auction engine or market for example can calculate the advertiser's conversion rate as it does their click-through rate. Conversions are advertiser-specified and can range from the user visiting a certain web page to actually buying a product from the advertiser.

Further to the above, the generalized second price auction (GSP) is known. A GSP auction ranks advertisers by value-per-impression and then displays the advertisers in this rank order across the slots on a page. To do this, GSP uses the advertiser bids to represent their value-per-click and computes click-through rates to represent the probability an advertiser's advertisement will be clicked. The value-per-impression of the advertiser is their click-through rate multiplied by their bid. The intuition behind this ranking procedure is that if advertisers actually reported their value-per-click as their bid, then this rank ordering would maximize the total social welfare (i.e., it would be socially optimal).

Implicit in the above description of GSP are a number of assumptions, such as (1) the advertiser click-through rate for a given slot is the product of an advertiser specific term and a slot specific term, i.e., the click-through rates are factorable; (2) the slot specific click-through rate is monotone non-increasing in slot number, i.e., top (lower numbered) slots generate more clicks than bottom (higher numbered) slots; and (3) the advertiser's value for a click is the same regardless of the slot it comes from, that is, there is no slot specific conversion rate term. It is assumed that these assumptions hold, but may be relaxed as described further herein.

From the first assumption, the click-through rates are factorable such that the click-through rate for an advertiser i for slot j (notated cᵢ^{j}) is the product of an advertiser specific term (notated cᵢ) and a slot specific term (notated c^{j}), i.e., cⱼⁱ=c^{j}cᵢ. From the second assumption, the c^{j}s satisfy c^{j}≧c^{j+1}.

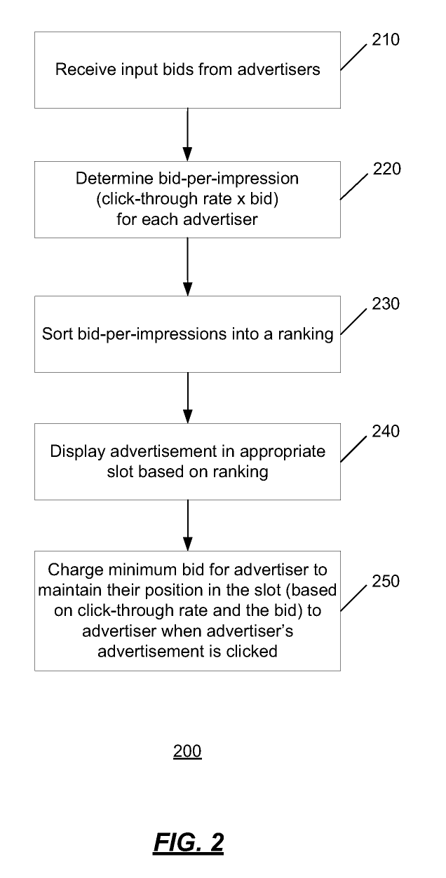

A technique for a GSP auction is described with respect to the operational flow of FIG. 2. At operation 210, the GSP auction, for k slots, receives input bids from advertisers. Letting bᵢ represent the bid-per-click of advertiser i, and letting bᵢcᵢ (i.e., the click-through rate multiplied by the bid) be the bid-per-impression of advertiser i, the bid-per-impression may be determined for each advertiser at operation 220, and the bids (and hence the bidders) may be sorted by bid-per-impression into a ranking, at operation 230. This may be performed by letting iⱼ be the index of the bidder with the jth highest bid-per impression, and for all j, bᵢ_{ⱼ}cᵢ_{ⱼ}≧bᵢ_{ⱼ₊₁}cᵢ_{ⱼ₊₁}. Additionally, for all j, let pⱼ be the minimum bid for advertiser iⱼ to maintain their position in slot j:

$${p}_{j} = \frac{{b}_{{i}_{j + 1}} {c}_{{i}_{j + 1}}}{{c}_{{i}_{j}}} .$$

Then, at operation 240, for j≦k, the advertisement for advertiser iⱼ is shown in slot j based on the ranking. At operation 250, for j≦k, if advertisement iⱼ is clicked, a fee equal to the minimum bid pⱼ is charged to advertiser iⱼ.

A truthful auction is one where it is a dominant strategy for all bidders to submit bids equal to their true values. GSP is a generalization of the second price auction which is truthful; however, it is not itself truthful. This means that it cannot be expected that advertiser i will submit a bid-per-click, bᵢ, that is equal to their value-per-click, vᵢ. It has been theorized that in equilibrium, when advertisers have values-per-click of v₁, . . . , vₙ and values-per-impression of v₁c₁, . . . , vₙcₙ, the sorted orders of advertisers by value-per-impression and by bid-per-impression are identical. Thus, in equilibrium the advertiser with the jth highest value-per-impression gets the jth highest slot, which has the highest click-through rate. This assumes that all clicks are equal. This assumption may be relaxed as described further herein.

This game-theoretic analysis is based on the following observation about an advertiser's utility, i.e., their value less their payment. Advertiser i's utility for slot j at price p is uᵢ^{j}(p)=cᵢ^{j}(vᵢ−p), since if there is a click with probability cᵢ^{j}, the advertiser gets their value vᵢ but pays p. The assumption on the monotonicity of slots allows for the assumption that at any price p all advertisers have higher utility for top (lower numbered) slots.

Social welfare may be defined. Let iⱼ be the ordering defined by the bids-per-impression in GSP, then the social welfare is

$${\sum }_{j = 1}^{k} {v}_{{i}_{j}} {c}_{{i}_{j}} {c}^{j} .$$

This sum is maximized when the ordering of values-per-impression coincides with the ordering of bids-per-impression. In equilibrium, GSP maximizes the social welfare. Notice that the social welfare includes the welfare of the advertisers (which is their total value less their total payments) and the welfare of GSP (which is the total payments).

The assumption that all clicks are equal may be relaxed. Conversion tracking allows for the estimation of the likelihood that a click will generate a conversion when the user visits the advertiser's website. A recent empirical study showed that the conversion rates on the bottom (higher numbered) slots are generally higher than conversion rates on the top (lower numbered) slots. This leads to a conclusion that clicks on bottom slots are more valuable to advertisers than clicks on top slots. However, it has been shown that GSP does not maximize the social welfare (i.e., does not perform optimally) when conversion rates are not uniform across slots. Studies have shown that the social welfare of GSP can be as much as 30% less than optimal.

The payment rule can be modified in GSP using conversion rates that are automatically calculated by the conversion rate tracking system being used. The equilibrium in the resulting auction maximizes the social welfare.

In an implementation, the system may maintain a similar pay-per-click business model and user interface to GSP but may take into account the conversion tracking data. Assumptions that may be placed on conversion rates include (1) the advertiser conversion rate for a given slot is the product of an advertiser specific term and a slot specific term, i.e., the conversion rates are factorable; and (2) the product of the slot specific click-through rate and the slot specific conversion rate is monotone non-increasing in slot number, i.e., top (lower numbered) slots generate more conversions per impression than bottom (higher numbered) slots.

Notice that if the first assumption does not hold, then these conversion rates are not appropriate for a GSP-style auction. If the second assumption does not hold, then the ranking order used by GSP is inappropriate. However, in such a case, the slots may be renamed so that slot j is the one with the jth highest number of conversions per impression, without loss of generality.

From the first assumption, the conversion rates are factorable in the following sense. The conversion rate for an advertiser i for slot j (notated aᵢ^{j}) is the product of an advertiser specific term (notated aᵢ) and a slot specific term (notated a^{j}), i.e., aᵢ^{j}=a^{j}aᵢ. From the second assumption, the a^{j}s and c^{j}s satisfy c^{j}a^{j}≧c^{j+1}a^{j+1}.

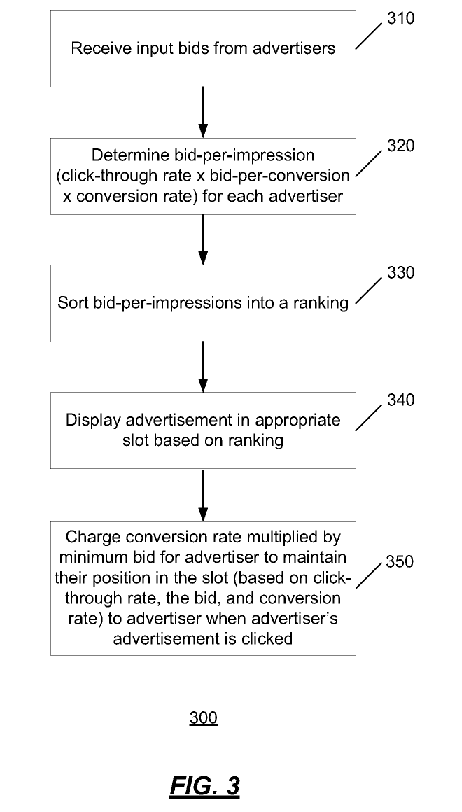

A generalized acquisition-aware second price (GASP) auction takes conversion rates into account. FIG. 3 is an operational flow of an implementation of a method 300 of a GASP auction. At operation 310, for k number of slots, input bids are received from advertisers. Let bᵢ represent the bid-per-conversion of advertiser i, and let bᵢcᵢaᵢ be the bid-per-impression of advertiser i, where cᵢ is the click-through rate of each advertiser and aᵢ is the conversion rate of each advertiser. The bid-per-impression for each advertiser may be determined at operation 320.

At operation 330, the bids (and hence the bidders) may be sorted by bid-per-impression into a ranking. In an implementation, this may be performed by letting iⱼ be the index of the bidder with the jth highest bid-per-impression, for all j, bᵢ_{ⱼ}cᵢ_{ⱼ}aᵢ_{ⱼ}≧bᵢ_{ⱼ₊₁}cᵢ_{ⱼ₊₁}aᵢ_{ⱼ₊₁} (where j+1 is the next slot), and for all j, letting pⱼ be the minimum bid for advertiser iⱼ to maintain their position in slot j:

$${p}_{j} = \frac{{b}_{{i}_{j + 1}} {c}_{{i}_{j + 1}} {a}_{{i}_{j + 1}}}{{c}_{{i}_{j}} {a}_{{i}_{j}}} .$$

At operation 340, for j≦k, the advertisement for advertiser iⱼ is shown in slot j based on the ranking. At operation 350, for j≦k, if advertisement iⱼ is clicked, aᵢ_{ⱼ}^{j}pⱼ (i.e., conversion rate multiplied by minimum bid of advertiser to maintain their position) is charged as a fee to advertiser iⱼ. It is noted that aᵢ_{ⱼ}^{j}pⱼ simplifies to

$$\frac{{b}_{{i}_{j + 1}} {c}_{{i}_{j + 1}} {a}_{{i}_{j + 1}}}{{c}_{{i}_{j}}} .$$

Additionally, if one wanted a pay-per-conversion auction instead of a pay-per-click auction, pⱼ advertiser may be charged iⱼ upon conversion. Constrained to a pay-per-click model, this payment may be scaled by iⱼ's conversion rate for slot j to get the appropriate payment.

A game-theoretic analysis of GASP follows from the previous analysis of GSP. It shows that under the assumptions that click-through rates and conversion rates are factorable and that the impressions in top (lower numbered) slots lead to more conversions than bottom (higher numbered) slots, in equilibrium GASP maximizes the social welfare. This game-theoretic analysis is based on the following observation about an advertiser's utility. Advertiser i's utility for slot j at price aᵢ^{j} is uᵢ^{j}(p)=vᵢcᵢ^{j}aᵢ^{j}(vᵢ−p), since if there is a conversion (with probability cᵢ^{j}aᵢ^{j}), the advertiser gets their value vᵢ, but if there is a click (with probability cᵢ^{j}), the advertiser pays aᵢ^{j}p. It is noted that the assumption on the monotonicity conversions per impression across the slots allows for the assumption that at any p all advertisers have higher utility for top (lower numbered) slots.

The conversion rate for advertiser i in slot j is the product of a slot specific term a^{j} and an advertiser specific term aᵢ. In an implementation of GASP, a^{j} may be an aggregate, over advertisers with conversion rate tracking enabled, of the conversion rate of slot j. The implementation may allow advertisers with conversion tracking enabled to opt-in to a conversion adjustment. Advertisers with a conversion adjustment may see their adjusted bid-per-click displayed as a product of their conversion rate with their bid-per-conversion. The bid they place in the auction is this bid-per-conversion. For advertisers enabling the conversion adjustment for the first time, a suggested bid-per-conversion may be calculated equal to their current bid-per-click divided by their conversion rate (thus, their adjusted bid-per-click may be equal to their original bid-per-click). However, as their conversion rate changes over time, this adjusted bid-per-click may change. For advertisers i that do not opt-in to the conversion adjustment (or do not have conversion tracking turned on), assume a conversion rate of aᵢ=1 (in the definition of GASP) and therefore their bid-per-click is equated with their bid-per-conversion.

In an implementation, a simplified version of GASP, referred to as simplified generalized acquisition-aware second price or SGASP, may not use conversion tracking for each advertiser. A difference between SGASP and the original GSP is the payment calculation. For SGASP, assume aᵢ=1 for all i (i.e., the advertiser specific conversion rates equal 1). However, a^{j} may still be determined by aggregating over the advertisers with conversion tracking enabled.

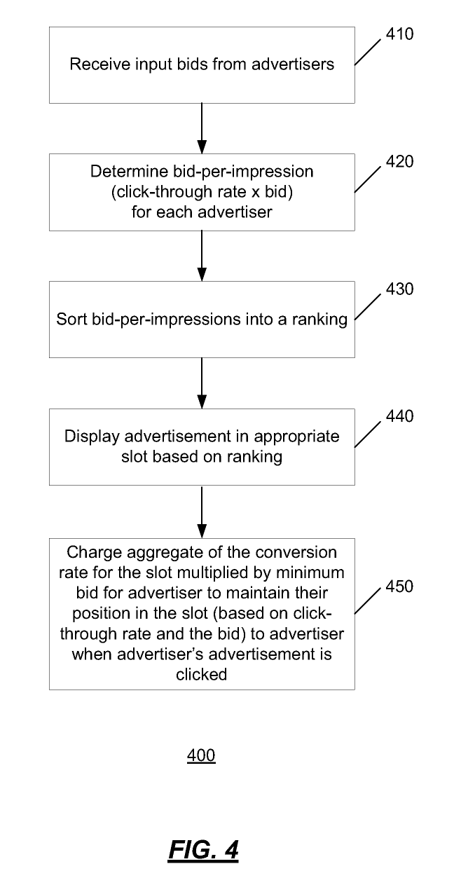

FIG. 4 is an operational flow of an implementation of a method 400 of a simplified generalized acquisition-aware second price (SGASP) auction. At operation 410, the SGASP auction, for k slots, receives input bids from advertisers. Let bᵢ represent the bid-per-click of advertiser i, and let bᵢcᵢ be the bid-per-impression of advertiser i. The bid-per-impression of each advertiser may be determined at operation 420.

At operation 430, the bids (and hence the bidders) may be sorted by bid-per-impression into a ranking. In an implementation, this may be performed by letting iⱼ be the index of the bidder with the jth highest bid-per-impression, for all j, bᵢ_{ⱼ}cᵢ_{ⱼ}≧bᵢ_{ⱼ₊₁}cᵢ_{ⱼ₊₁}, and for all j, let pⱼ be the minimum bid for advertiser iⱼ to maintain their position in slot j:

$${p}_{j} = \frac{{b}_{{i}_{j + 1}} {c}_{{i}_{j + 1}}}{{c}_{{i}_{j}}} .$$

At operation 440, for j≦k, the advertisement for advertiser iⱼ is shown in slot j based on the ranking. At operation 450, for j≦k, if advertisement iⱼ is clicked, a^{j}pⱼ (the slot specific term multiplied by the minimum bid) is charged as a fee to advertiser iⱼ.

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A paid search method comprising:
determining a bid-per-impression for each of a plurality of advertisers, each bid-per-impression being based on an associated conversion rate; and
providing a plurality of advertisements on a web page, each advertisement being provided in an associated slot on the web page based on the bid-per-impression of the advertiser associated with the advertisement.

2. The method of claim 1, wherein each bid-per-impression is further based on an associated click-through rate and an associated bid-per-conversion.

3. The method of claim 2, wherein determining the bid-per-impression comprises multiplying the click-through rate with the bid-per-conversion and with the conversion rate.

4. The method of claim 1, further comprising sorting the bid-per-impressions into a ranking, wherein providing the advertisements on the web page is based on the ranking.

5. The method of claim 1, further comprising receiving a plurality of bids prior to determining the bid-per-impression for each of the plurality of advertisers, each bid being associated with a bid-per-conversion of one of the plurality of advertisers.

6. The method of claim 1, further comprising receiving a click on one of the advertisements on the web page and charging the advertiser associated with the advertisement a fee based on the associated conversion rate.

7. The method of claim 6, wherein the fee is based on a multiplication of the conversion rate with a minimum bid for the advertiser to maintain the associated slot.

8. The method of claim 1, wherein providing the plurality of advertisements on the web page comprises displaying the plurality of advertisements on the web page.

9. A paid search method comprising:
providing a plurality of advertisements in a plurality of associated slots on a web page;
receiving a click on one of the advertisements on the web page; and
charging an advertiser associated with the advertisement a fee based on an associated conversion rate.

10. The method of claim 9, wherein the fee is based on a multiplication of an aggregate of the conversion rate for the slot with a minimum bid for the advertiser to maintain the associated slot.

11. The method of claim 10, further comprising determining the minimum bid without a conversion rate.

12. The method of claim 9, further comprising determining a bid-per-impression for each advertiser associated with the advertisements.

13. The method of claim 12, further comprising sorting the bid-per-impressions into a ranking, wherein providing the advertisements on the web page is based on the ranking.

14. The method of claim 9, further comprising receiving a plurality of bids prior to determining the bid-per-impression for each of the plurality of advertisers.

15. A paid search system comprising:
an advertisement engine that provides a plurality of advertisements in a plurality of associated slots on a web page; and
a payment engine that charges an advertiser associated with a selected one of the advertisements a fee based on an associated conversion rate.

16. The system of claim 15, wherein the fee is based on a multiplication of an aggregate of the conversion rate for the slot with a minimum bid for the advertiser to maintain the associated slot.

17. The system of claim 15, wherein the fee is based on a multiplication of the conversion rate with a minimum bid for the advertiser to maintain the associated slot.

18. The system of claim 15, further comprising an auction engine that determines a bid-per-impression for each of a plurality of advertisers.

19. The system of claim 18, wherein each bid-per-impression is based on the associated conversion rate.

20. The system of claim 18, wherein the auction engine sorts the bid-per-impressions into a ranking, and wherein the advertisement engine provides the advertisements on the web page based on the ranking.
